(19) United States
(12) Patent Application Publication
(10) Pub. No.: US 2011/0052111 A1
(43) Pub. Date: Mar. 3, 2011

(54) MODULAR ROTOR ASSEMBLY

(75) Inventors: Edward S. Czechowski, Orchard Park, NY (US); Robert Small, Horseheads, NY (US); John R. Battershell, Hamburg, NY (US); Robert M. Kolodziej, Varysburg, NY (US)

(73) Assignee: CAMERON INTERNATIONAL CORPORATION, Houston, TX (US)

(21) Appl. No.: 12/943,793

(22) Filed: Nov. 10, 2010

Related U.S. Application Data
(63) Continuation of application No. 10/889,146, filed on Jul. 12, 2004.

(51) Int. Cl. F16C 33/74; B23P 15/14; F16C 33/10

(52) U.S. Cl. 384/130; 29/893.1; 384/322

(57) ABSTRACT

Portions of the drive system for a piece of rotating equipment are pre-assembled into a subassembly. The subassembly can be held together by a carrier that is fabricated to accept the components in a proper alignment so that the carrier can be installed as a unit. In the preferred embodiment the carrier becomes a gearbox housing component that is installed saving the need for individual component alignment. Using the modular approach. The modular approach allows an assembly having a single part number to apply to a given compressor unit and further allows standardization of air ends of compressors with specific impellers and inlets added to meet requirements of a specific application.

### CROSS REFERENCE TO RELATED APPLICATION

This application is a continuation of U.S. patent application Ser. No. 10/889,146, entitled “MODULAR ROTOR ASSEMBLY”, filed Jul. 12, 2004, which is herein incorporated by reference in its entirety.

### FIELD OF THE INVENTION

The field of this invention is modular pre-assembly of rotating components of industrial machinery and more specifically compressors.

### BACKGROUND OF THE INVENTION

Typically, when an end user specifies a compression need from a manufacturer the manufacturer tries to provide a unit from an available product line to meet the performance and price parameters given. Since the potential applications and the specific parameters given by different users can vary, each unit may be specifically built for a unique application. For example, in a drive system, the final driven speed for a unit can vary. Generally, various components of the drive system to be installed in a gearbox have to be individually assembled and aligned with significant precision to prevent premature wear and failure. The assembly in the gearbox includes inner bearings and outer housings, a driven pinion/shaft, oil seals, an impeller to go into the gearbox housing with a gas seal around the shaft, associated bits and pieces of the oil lubrication system, and a shaft end cap and associated fittings.

Assembling these components for every unit is labor intensive and therefore expensive. It requires stocking of many options for given components that can be assembled together in only so many discrete ways. This requires greater costs for storage, proper inventory and, most of all, in assembly costs for a given unit.

Another costly issue is the need to precision fabricate all the components to facilitate the alignment procedure. The individual part tolerances can add up, making the ultimate alignment more difficult. A failure to properly control alignment can result in premature bearing, seal, or gear set wear. Manually assembling and aligning each unit can be a significant portion of the total labor cost.

### SUMMARY OF THE INVENTION

There is provided a modular pre-assembly of some components of a drive into a carrier. In accordance with an embodiment of the present invention, a carrier is precision machined to accept drive components in an aligned condition to each other for quick assembly into the gearbox housing. Portions of the drive system for a piece of rotating equipment are pre-assembled into a subassembly. The subassembly can be held together by a carrier that is fabricated to accept the components in a proper alignment so that the carrier can be installed as a unit. In one embodiment, the carrier becomes a gearbox housing component that is installed, saving the need for individual component alignment. This modular approach allows an assembly having a single part number to apply to a given compressor unit and further allows standardization of air ends of compressors with specific impellers and inlets added to meet requirements of a specific application.

### BRIEF DESCRIPTION OF THE DRAWINGS

FIG. 1 is the currently known way of assembling the components of the drive that requires significant time to insure proper component alignment; and

FIG. 2 shows the modular approach of the present invention where some of the drive components are pre-assembled into a carrier.

### DETAILED DESCRIPTION OF SPECIFIC EMBODIMENTS

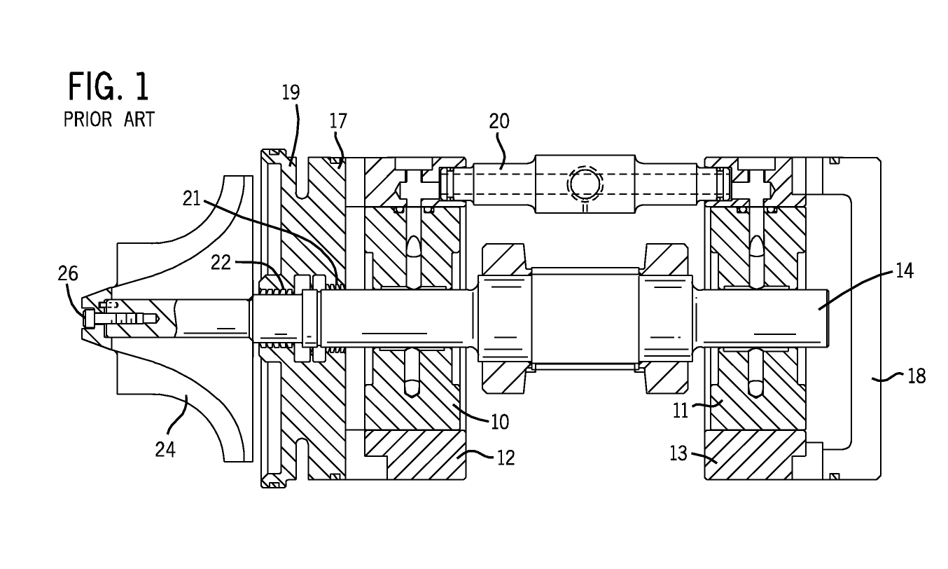

FIG. 1 represents the known way to assemble the illustrated components. Inner bearings 10 and 11 and outer housings 12 and 13 are mounted on a gearbox or compressor housing. Generally, the gearbox housing is horizontally split and the mating halves have a semicircular cutout so that upon assembly, the bearings are respectively supported in the opposed gearbox housing walls. A geared pinion shaft 14 extends through bearings 10 and 11. An end cap 18 goes over the end of the shaft 14. Various piping manifolds 20, which are connected to each of the bearings 10 and 11, are illustrated. An oil seal 21 and a gas seal 22 are mounted to respective housings 17 and 19. The gearbox housing can be integrally cast in halves to form the gearbox lower and upper housings so that the assembly is completed around the housings 12 and 13 and housings 17 and 19. An impeller 24 is fitted to the end of the pinion shaft 14 and secured with a bolt 26, preferably through the open end of the scroll or gearbox housing. The stocking of these individual components and the custom combination of them to meet the requirements of a specific unit adds assembly, record keeping, and storage costs. The bearings 10 and 11 must be aligned to the pinion shaft 14 so as to maintain alignment of the gear meshes in the gearbox housing.

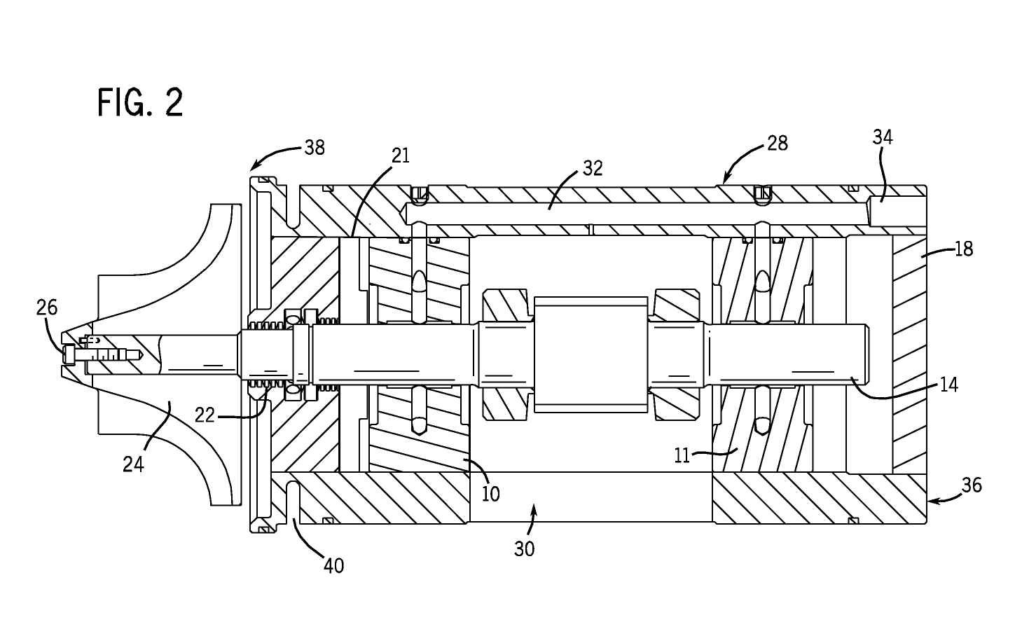

FIG. 2 illustrates an embodiment of the present invention. A carrier or cartridge 28 holds the bearings 10 and 11, seals 21 and 22, end cap 18, and pinion shaft 14. The carrier 28 has an opening 30 to allow a bull gear access to mesh with the pinion shaft 14. Oil passages 32 can be integrated into the carrier 28 and single or multiple end connections 34 can be provided at an end 36 of the carrier 28. A reconfigured end cap 18 is mounted at the end 36 of the carrier 28. Oil seal 21 is now within the carrier 28 while gas seal 22 is at end 38 of the carrier 28.

Those skilled in the art will appreciate that the components mounted to the carrier 28 are aligned by virtue of assembly to the precision machined carrier 28. The carrier 28 with the components mounted to it can be fitted to the lower part of the gearbox housing and scroll until the gas seal 22 is in a proper location as determined by alignment of groove 40 with an opening in the scroll or gearbox housing for insertion of a retaining Woodruff key or equivalent through the scroll or gearbox housing and into the groove 40. At that point the top of the gearbox housing and scroll can be mounted to complete the assembly shown in FIG. 2. The impeller 24 can be mounted to pinion shaft 14 either before or after the top halves of the gearbox housing and scroll are put on.

Those skilled in the art will appreciate that although the preferred embodiment illustrated is in the context of a centrifugal compressor, the illustrated pre-assembly technique can be used on a variety of rotating equipment applications and is applicable regardless of the size of the components or the horsepower of the connected driver. The pre-assembly technique can be applied to directly driven rotating equipment that does not employ a gearbox and a pinion such as 14. Configuring the carrier 28 to include oil passages 32 further speeds up the assembly process. The use of an alignment groove such as 40, which can take a variety of forms and does not need to extend circumferentially, also insures that the carrier 28 is properly positioned with respect to the gearbox and the impeller 24 in the surrounding scroll. The use of the carrier 28 assures alignment of the components mounted therein and reduces assembly time. The assembly can be stocked as a single part number and be warehoused pre-assembled. For a centrifugal compressor assembly, the assembled components in a carrier 28 allow the air end of the compressor to become a common assembly. That is, the impeller 24 and inlets (not shown) can be assembled locally to meet the requirements of a specific installation. The high level of alignment that can be obtained with the use of the carrier or cartridge will enhance the reliability of the rotating equipment and will provide additional hours of running time without maintenance or costly repairs. The cartridge concept is applicable on installations where there is a gearbox housing that serves as a base or in other applications where the base is a structure, such as when the drive is direct from driver to the shaft.

The foregoing disclosure and description of the invention are illustrative and explanatory thereof, and various changes in the size, shape and materials, as well as in the details of the illustrated construction, may be made without departing from the spirit of the invention.

1. A method of assembling a piece of rotating equipment, comprising:
pre-aligning a shaft and bearings in a one-piece cartridge, wherein the one-piece cartridge comprises an integral internal oil passage generally parallel to the shaft and extending to at least one of the bearings, and an input extending into the one-piece cartridge along a direction generally parallel to the shaft, wherein the input is configured to provide oil to the integral internal oil passage; and
assembling the one-piece cartridge to a housing for the rotating equipment.

2. The method of claim 1, wherein the integral internal oil passage comprises an opening at an axial end face of the one-piece cartridge, and the input is coupled to the opening.

3. The method of claim 1, comprising:
providing a gear on the shaft;
mounting the one-piece cartridge to a gearbox housing; and
providing lateral access in the one-piece cartridge to the gear.

4. The method of claim 3, comprising aligning at least one seal to the shaft in the one-piece cartridge.

5. The method of claim 3, comprising:
providing a split gearbox having the gearbox housing with upper and lower portions;
providing a centrifugal compressor scroll with the lower portion of the gearbox housing; and
mounting the one-piece cartridge to the lower portion of the gearbox housing to engage the gear to a drive within the split gearbox.

6. The method of claim 5, comprising electively locking the one-piece cartridge to the scroll when the gear is engaged to the drive.

7. The method of claim 6, comprising providing an oil seal for the split gearbox and a gas seal for the scroll on the one-piece cartridge.

8. The method of claim 1, wherein the integral internal oil passage extends to first and second bearings in fixed positions within the one-piece cartridge.

9. A system, comprising:
a carrier, comprising:
a single structure having first and second bearing support regions in fixed positions relative to one another, wherein the carrier is configured to self-contain and align first and second bearings in the respective first and second bearing support regions in the fixed positions relative to one another; and
at least one internal oil passage extending lengthwise through the single structure from an oil line connector within a longitudinal end of the carrier to the first and second bearings.

10. The system of claim 9, comprising an alignment groove in the carrier.

11. The system of claim 9, comprising an oil seal and a gas seal configured to seal about the geared shaft.

12. The system of claim 9, wherein the carrier comprises an opening into a lateral side of the carrier in a direction crosswise to a longitudinal axis of the carrier.

13. The system of claim 9, wherein the single structure supports the first and second bearings during installation and removal of the carrier, and the at least one internal oil passage is a fixed portion of the single structure.

14. A subassembly for rotating equipment, comprising:
a one-piece carrier configured to receive and align a plurality of bearings and a geared shaft supported by the plurality of bearings, the carrier comprising:
an opening in a lateral side of the carrier to enable a gear to mesh with the geared shaft in a direction crosswise to a rotational axis of the geared shaft; and
an internal oil passage integrally formed within the one-piece carrier, wherein the internal oil passage is configured to carry oil from an input on a first axial end face of the one-piece carrier to at least one of the bearings, wherein the input extends axially into the one-piece carrier relative to a rotational axis of the plurality of bearings in the one-piece carrier.

15. The subassembly of claim 14, wherein the one-piece carrier comprises a groove integrally formed in an exterior of the one-piece carrier, wherein the groove is configured to align the one-piece carrier to a base and to secure the one-piece carrier with respect to the base.

16. The subassembly of claim 14, wherein the one-piece carrier consists essentially of a one-piece multi-bearing support with the internal oil passage extending to the plurality of bearings.

17. The subassembly of claim 14, wherein the one-piece carrier supports the plurality of bearings and the geared shaft during installation and removal of the one-piece carrier.

18. A subassembly for rotating equipment comprising:
a one-piece carrier having a plurality of integral bearing support regions in fixed positions relative to one another, wherein the one-piece carrier has a cylindrical exterior having a generally constant outer diameter surrounding the plurality of integral bearing support regions;
a plurality of bearings, wherein the one-piece carrier is configured to self-contain and align the plurality of bearings in the plurality of integral bearing support regions in the fixed positions relative to one another;
a geared shaft supported and aligned by the bearings;
an oil passage integrally formed within a wall of the one-piece carrier generally parallel to the geared shaft and configured to supply oil to the plurality of bearings, wherein the oil passage comprises an end opening;
an opening in a lateral side of the one-piece carrier to enable a gear to mesh with the geared shaft in a direction crosswise to a rotational axis of the geared shaft;
an impeller coupled to the geared shaft at a first end of the one-piece carrier, wherein the impeller has a diameter less than or equal to the generally constant outer diameter of the one-piece carrier, and the impeller protrudes from the first end of the one-piece carrier;
a groove integrally formed within the wall of the one-piece carrier, wherein the groove is configured to align the one-piece carrier to a base and to secure the one-piece carrier with respect to the base; and
an end cap coupled to a second end of the one-piece carrier opposite from the first end, wherein the end cap is configured to seal the second end of the carrier closed, and the end opening extends through an axial end face axially into the one-piece carrier relative to the rotational axis.

19. The subassembly of claim 18, wherein the one-piece carrier supports the plurality of bearings during installation and removal of the one-piece carrier.

20. The subassembly of claim 18, wherein the shaft does not extend through the end cap.
